(19) United States
(12) Patent Application Publication
(10) Pub. No.: US 2019/0118191 A1
(43) Pub. Date: Apr. 25, 2019

(54) ELECTROSTATIC PRECIPITATOR AND METHOD

(71) Applicant: Staffordshire University, Stafford (GB)

(72) Inventor: Derek Wardle, Stoke on Trent (GB)

(21) Appl. No.: 16/075,499

(22) PCT Filed: Feb. 4, 2016
(86) PCT No.: PCT/GB2016/050262

§ 371 Date: Aug. 3, 2018

(51) Int. Cl. B03C 3/12; B03C 3/08; B03C 3/41; B03C 3/49

(52) U.S. Cl. CPC B03C 3/12; B03C 3/08; B03C 2201/04; B03C 3/49; B03C 3/41

(57) ABSTRACT

An electrostatic precipitator assembly (100), the assembly including an electrostatic charging mechanism (106) for inducing a first charge to particulate material being carried in a gas flowing past the electrostatic charging mechanism (106). A chamber being provided downstream of the electrostatic charging material, which includes an electrode or electrodes (103) which are grounded or can have an opposite charge to the first charge applied thereto, such that the charged particulate material is attracted to and collects on the electrode or electrodes ((103). A further separator is provided downstream of the electrode or electrodes (103), the further separator including an electronically chargeable permeable member (114) through which the gas flows in use, with the permeable member (114) in use having the same charge as the particulate material so as to repel the particulate material and substantially prevent the particulate material from passing therethrough.

This invention relates to electrostatic precipitators, and also a method of separating particulate material from a gas.

Electrostatic precipitators are devices used to remove fine particulate material such as dust and smoke from gases. Such devices on a large scale can be used in a range of applications including for instance in power stations to remove particulate material from flue gases. On a smaller scale the devices can be used domestically and can be used in heating appliances and especially microcombined heat and power units.

Generally in such devices the gases which are carrying the particulate material are caused to flow through the device. In the region of the device inlet an electrostatic charging mechanism is provided which induces a charge on the particulate material, but with the gases having substantially no charge induced thereon.

The device includes a chamber through which the gases subsequently flow. Located in the chamber is an oppositely charged or grounded electrode or electrodes. The charged particulate material is attracted to the electrode or electrodes and adheres thereto, thereby removing the particulate material from the gases which continue through and out of the device.

In practice a certain amount of particulate material tends to remain in the flowing gases. Downstream filters may be provided to entrap the remaining particulate material, but these will affect the gas flow, and particularly as particulate material becomes entrapped by the filters, and thereby tends to block the filters.

The burning of solid biomass such as wood, dedicated agricultural crops and residuals instead of fossil fuels is becoming more widespread as a source of power. Inadequate control of pollutants entering the atmosphere, especially those resulting from combustion, has debilitating effects upon the environment and human health. One area of concern is particulate matter entrained in flue gases resulting from the combustion of solid biomass. Emissions of particle sizes ≤10 μm are of particular concern, because they pass through the respiratory system and are deposited in the alveoli of the lungs where they remain.

The current processes of removal of particulate matter from gases by electrostatic precipitation commonly allows re-entrainment of the particulate matter in the gas stream due to back corona discharge and loss or reversal of charge on contact with the plates. Rapping, a mechanical procedure for removing the built up particulates on the collection plates, is another main cause of re-entrainment. Sneakage allows the passage of uncharged particulate matter through cross sections of the precipitator such as between the collecting plates and structural members.

Generally, electrostatic precipitators are not chosen for small scale heat and power generation plants due to the high capital cost compared to other methods such as filters and cyclones; however, size for size running costs are often less than these other systems. It follows, therefore, that if the capital outlay and size of ESP units can be substantially reduced, without loss of efficiency, they would become a viable proposition for small Combined Heat and Power (CHP) units as well as domestic heating and hot water installations. A reduction in size and cost would allow their more efficient use in commercial, residential and personal air treatment units.

According to a first aspect of their invention there is provided an electrostatic precipitator assembly, the assembly including an electrostatic charging mechanism for inducing a first charge to particulate material being carried in a gas flowing past the electrostatic charging mechanism, a chamber downstream of the electrostatic charging material, the chamber including an electrode or electrodes which are grounded or can have an opposite charge to the first charge applied thereto, such that the charged particulate material is attracted to and collects on the electrode or electrodes, a further separator being provided downstream of the electrode or electrodes, the further separator including an electronically chargeable permeable member through which the gas flows in use, with the permeable member in use having the same charge as the particulate material so as to repel the particulate material and substantially prevent the particulate material from passing therethrough.

The assembly may include an electrical charging mechanism for the permeable member.

The permeable member of the further separator may be made of metal and may be made of stainless steel. The permeable member of the further separator may be in the form of a mesh, which may be woven. The mesh may have openings of between 100 and 500 microns, and more particularly between 200 and 400 microns.

The permeable member may be in the form of a hollow cylinder with a closed end and an open end into which open end gas flows in use.

According to a second aspect of the invention there is provided a method of separating particulate material from a gas, the method comprising causing the gas to flow past an electrostatic charging mechanism which induces a first electrostatic charge on the particulate material, then causing the gas to flow past an electrode or electrodes which are grounded or have an opposite charge to the first charge such that particulate material adheres onto the electrode or electrodes, then causing the gas to flow through an electrically chargeable permeable member, which permeable member has the same first charge so as to allow gas to pass therethrough but to repel any particulate material in the gas, and substantially prevent any particulate material from passing therethrough.

A first negative electrostatic charge may be induced in the particulate material, and the first charge may have a voltage of 10-30 kV.

A positive charge may be applied to the electrode or electrodes.

The gas may be caused to flow through an apparatus according to any of the above paragraphs.

Embodiments of the present invention will now be described, by way of example only, with reference to the accompanying drawings in which like reference numerals are used to depict like parts. In the drawings:

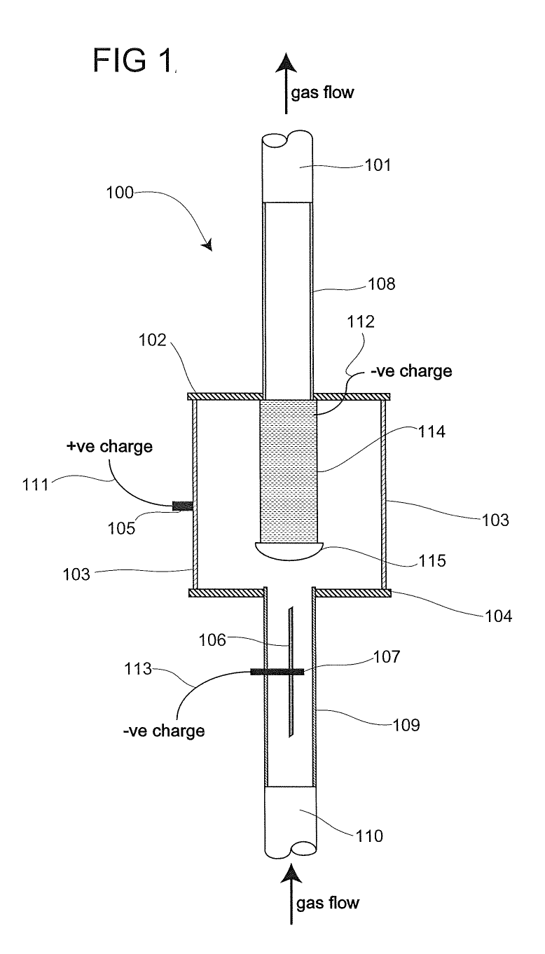

FIG. 1 shows a cross section of a first exemplary embodiment of an electrostatic precipitator apparatus

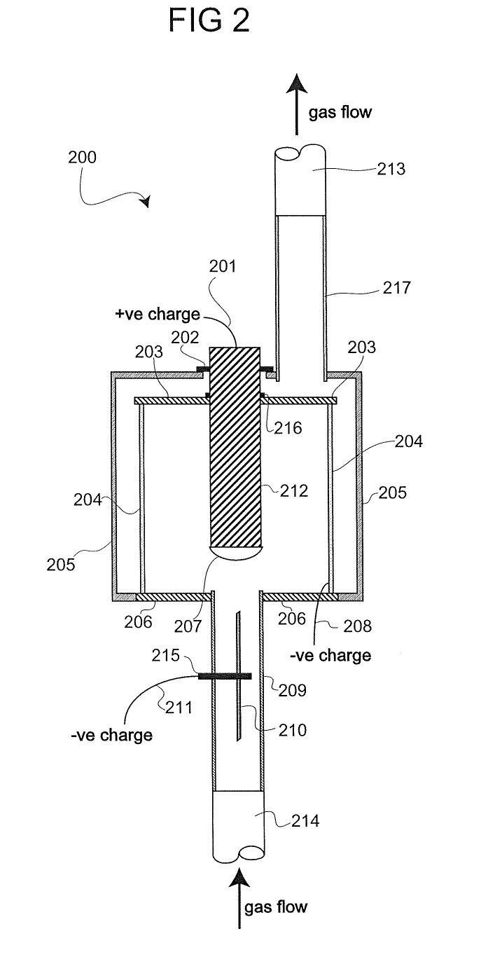

FIG. 2 shows a cross section of a second exemplary embodiment of an electrostatic precipitator apparatus

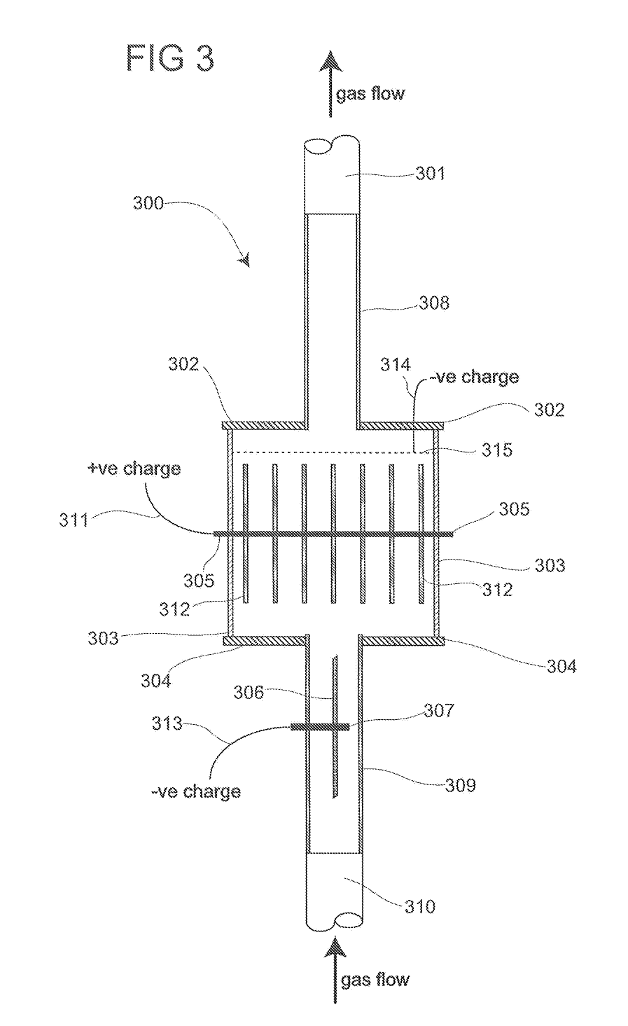

FIG. 3 shows a cross section of a third exemplary embodiment of an electrostatic precipitator apparatus

FIG. 1 depicts a cross-section of an exemplary embodiment of an electrostatic precipitator 100. The electrostatic precipitator 100 is shown fitted to a gas flue via an inflow 110 and an outflow 101. The electrostatic precipitator 100 comprises a particulate matter charging electrode 106 with a particulate matter collecting electrode 103 and a particulate matter repulsing mesh cylinder 114.

In this embodiment the collecting electrode 103 is positively charged, connected to an electrical source by a connector 105 and wire 111. The collecting electrode 103 is formed into a drum, with an inner surface and an outer surface, capped at one end by an insulating plate 102 and at an opposing end by an insulating plate 104. Insulating plate 104 allows ingress of gases by penetration by the elongate member 109. Insulating plate 102 allows egress of gases by penetration by the elongate member 108.

In this embodiment the insulating plate 102 and the insulating plate 104 are made from ceramic material.

In the embodiment described by FIG. 1 the repulsing mesh 114 is negatively charged, connected to an electrical source by a wire 112. In this embodiment the cylinder formed by the repulsing mesh 114 is located within the drum described by the collecting electrode 103. The repulsing mesh 114 has an inner surface and an outer surface as well as an end orientated towards the inflow of gases and an end orientated away from the inflow of gases. The end of the repulsing mesh 114 orientated towards the inflow of gases is capped by a particulate matter deflecting plate 115. The end of the repulsing mesh cylinder 114 orientated away from the inflow of gases abuts the insulating plate 102 causing gases to pass through the mesh before egress from the drum described by the collecting electrode 103.

In the described embodiment the repulsing mesh 114 is constructed from a steel mesh of 300 μm lattice size. The repulsing mesh 114 may be constructed from steel meshes of 50-1000 μm lattice size. The cylinder described by the repulsing mesh 114 is centrally located within the drum described by the collecting electrode 103.

In the described embodiment the particulate matter deflecting plate 115 is convex. In place of the particulate matter deflecting plate 115 the end of the repulsing mesh 114 orientated towards the inflow of gases may be capped by a further repulsing mesh unit.

The charging electrode 106 is suspended by attachment to a clamp 107 within an elongate member 109 with an inner surface and an outer surface. The elongate member 109 possesses an end orientated to accept inflowing gases and an end orientated to eject gases into the drum described by the collecting electrode 103. In this embodiment the charging electrode 106 is negatively charged and connected to an electrical source by a wire 113. In this embodiment the charging electrode 106 is a wire coil.

In the example embodiment the elongate member 108 with an inner surface and an outer surface has an end that penetrates the insulating plate 102 within the abutment described by the repulsing mesh 114 upon the insulating plate 102 in such a way that gases must pass through the repulsing mesh 114 before exiting the apparatus. The end of the elongate member 108 opposing that penetrating insulating plate 102 allows egress of gases from the electrostatic precipitator device 100 by attachment to outflow 101.

The elongate member 108 may be constructed from glass. The elongate member 108 may be constructed from a transparent material. The elongate member 108 may incorporate a viewing port or window. The elongate member 108 may incorporate or house apparatus for the detection or measurement of particulate matter. The elongate member 108 may abut the insulating plate 102.

The elongate member 109 may be constructed from glass. The elongate member 109 may be constructed from a transparent material. The elongate member 109 may incorporate a viewing port or window. The elongate member 109 may incorporate or house apparatus for the detection or measurement of particulate matter. The elongate member 109 may abut the insulating plate 104.

The electrostatic precipitator 100 is assembled in such a way that elongate member 109 and the drum described by collecting electrode 103 as well as the elongate member 108 are in fluid communication with each other.

FIG. 2 depicts a cross-section of an exemplary embodiment of an electrostatic precipitator 200. The electrostatic precipitator 200 is shown fitted to a gas flue via an inflow 214 and an outflow 213. The electrostatic precipitator 200 comprises a particulate matter charging electrode 210 with a particulate matter collecting electrode 212 and a particulate matter repulsing mesh 204.

In the described embodiment, the electrostatic precipitator 200 comprises a negatively charged particulate matter charging electrode 210. The charging electrode 210 is held by a clamp 215 within an elongate member 209 with an inner surface and an outer surface. The elongate member 209 has an end that penetrates the insulating plate 206 and an end that allows ingress of gases from the inlet 214. The elongate member 209 may alternatively abut the insulating plate 206. In this embodiment the charging electrode 210 is a wire coil.

In the example embodiment the particulate matter repulsing mesh 204 describes a cylinder with an inner surface and an outer surface, one end abutting the insulating plate 206 and another end abutting the insulating plate 203. The repulsing mesh 204 is situated within a case 205. The repulsing mesh 204 is negatively charged and connected to an electrical source by a wire 208.

The repulsing mesh 204 is constructed from a steel mesh of 300 μm lattice size. The repulsing mesh 204 may be constructed from a steel mesh of 50-1000 μm lattice size.

In the example embodiment the case 205 is made from plastic.

The collecting electrode 212 is situated within a drum described by the repulsing mesh 204. The collecting electrode 212 penetrates the insulating plate 203. The collecting electrode 212 penetrates the case 205. The air tight seals 202 and 216 are of a screw thread type including gaskets. The collecting electrode 212 may be removed from the electrostatic precipitator apparatus 200 to allow disposal of collected particulate matter. The collecting electrode 212 is centrally located within the drum described by the repulsing mesh 204.

In the example embodiment of the electrostatic precipitator 200 the collecting electrode 212 is made from steel and has an outer surface and has an end that is inserted into the electrostatic precipitator 200 through the case 205 and the insulating plate 203. In this embodiment the collecting electrode 212 is positively charged and attached to an electrical source by a wire 201.

In the example embodiment the insulating plate 203 and the insulating plate 206 are made from ceramic material.

An elongate member 217 with an inner surface and an outer surface has an end that penetrates the case 205 in such a way that gases must pass through the repulsing mesh 204 before exiting the apparatus. The end of the elongate member 217 opposing that penetrating case 205 allows egress of gases from the electrostatic precipitator device 200 to the outflow 213.

The elongate member 209 may be constructed from glass. The elongate member 209 may be constructed from a transparent material. The elongate member 209 may incorporate a viewing port or window. The elongate member 209 may incorporate or house apparatus for the detection or measurement of particulate matter.

The elongate member 217 may be constructed from glass. The elongate member 217 may be constructed from a transparent material. The elongate member 217 may incorporate a viewing port or window. The elongate member 217 may incorporate or house apparatus for the detection or measurement of particulate matter.

The electrostatic precipitator 200 is assembled in such a way that elongate member 209 and inside of the case 205 as well as the elongate member 217 are in fluid communication with each other.

FIG. 3 depicts a cross-section of an exemplary embodiment of an electrostatic precipitator 300. The electrostatic precipitator 300 is shown fitted to a gas flue via an inflow 310 and an outflow 301. The electrostatic precipitator 300 comprises a particulate matter charging electrode 306 with a particulate matter collecting electrode 312 and a particulate matter repulsing mesh 315.

In the described embodiment, the electrostatic precipitator 300 comprises a negatively charged particulate matter charging electrode 306. The charging electrode 306 is held by a clamp 307 within an elongate member 309 with an inner surface and an outer surface. The elongate member 309 has an end that penetrates the plate 304 and an end that allows ingress of gases from the inlet 310. The elongate member 309 may alternatively abut the plate 304. In this embodiment the charging electrode 306 is a wire coil.

In the example embodiment, the particulate matter repulsing mesh 315 is a square sheet with two surfaces. Each of the four sides of the repulsing mesh 315 is attached to the case 303. The repulsing mesh 315 is situated within the case 303. The repulsing mesh 315 is negatively charged and connected to an electrical source by a wire 314.

The repulsing mesh 315 is constructed from a steel mesh of 300 μm lattice size. The repulsing mesh cylinder 315 may be constructed from a steel mesh of 50-1000 μm lattice size.

In the example embodiment the case 303 is made from glass.

The collecting electrode 312 is situated within the case 303, such that gases, having entered the system, will meet the collecting electrode 312 before passing through the repulsing mesh 315. The collecting electrode 312 is held by a rod 305 that penetrates the collecting electrode 312 and the case 303. The collecting electrode 312 may be removed from the electrostatic precipitator apparatus 300 to allow disposal of collected particulate matter. In the example embodiment there are seven collecting electrode 312 bodies, but any number may be used.

In the example embodiment of the electrostatic precipitator 300 the collecting electrode 312 is made from steel and is a flat square sheet with two surfaces. In this embodiment the collecting electrode 312 is positively charged and attached to an electrical source by a wire 311, via the rod 305. The rod 305 conducts electrical charge and holds the collecting electrode 312 within the case.

In the example embodiment the case 303 is made from glass material. The plate 304 and the plate 302 are attached to the case in a way to prevent gases or particulate matter from escaping the apparatus. The plate 304 and the plate 302 are made from glass.

An elongate member 308 with an inner surface and an outer surface has an end that penetrates the plate 302 in such a way that gases must pass through the repulsing mesh 315 before exiting the apparatus. The end of the elongate member 308 opposing that penetrating plate 302 allows egress of gases from the electrostatic precipitator device 300 to the outflow 301.

The elongate member 308 may be constructed from glass. The elongate member 308 may be constructed from a transparent material. The elongate member 308 may incorporate a viewing port or window. The elongate member 308 may incorporate or house apparatus for the detection or measurement of particulate matter.

The elongate member 309 may be constructed from glass. The elongate member 309 may be constructed from a transparent material. The elongate member 309 may incorporate a viewing port or window. The elongate member 309 may incorporate or house apparatus for the detection or measurement of particulate matter.

The electrostatic precipitator 300 is assembled in such a way that elongate member 308 and inside body described by the case 303 and plate 304 and plate 302, as well as the elongate member 309 are in fluid communication with each other.

The electrostatic precipitator may be manufactured from any suitable materials. For example, the electrostatic precipitator apparatus may be made from steel. Alternatively, the electrostatic precipitator apparatus may be made from copper. Where insulating materials are required these may be manufactured from any suitable material. For example insulating bodies may be made from plastic, ceramics and glass. The insulating bodies may be made from resins.

Variations of the described embodiments are envisaged, for example, the features of all of the disclosed embodiments may be combined in any way.

Where cylindrical structures are used these could be substituted by other elongate bodies having an inside and an outside. Where drums are described suitable boxes and other bodies could be manufactured. For example drums that have a profile that is square, elliptical, hexagonal, octagonal or other suitable shape may be employed.

The particulate matter deflecting plate may be concave, convex or flat. The particulate matter deflecting plate may be conical or shaped otherwise to allow beneficial flow of gases.

A plurality of matter repulsing meshes may be situated within a drum described by a charge collecting electrode. Alternatively a plurality of charge collecting electrodes may be situated within a drum described by a matter repulsing mesh.

Matter repulsing meshes may penetrate or abut multiple insulating plates. Collecting electrodes may abut or penetrate multiple insulating plates.

The embodiments described make use of charging electrodes and repulsing meshes that are negatively charged, and positively charged collecting electrodes, but electrodes with differing combinations of polarities can be envisaged. Collecting plates that are not directly charged by an electrical source, but are grounded may be employed. Meshes that are not directly charged by an electrical source, but are grounded, may be employed.

A plurality of elongate members for the ingress or egress of gases from the system may be envisaged, to enter the apparatus at a plurality of angles.

The collecting electrode may be furnished with fluting, spikes, or otherwise suitably textured to aid in the electrical adhesion of particulate matter.

The charging electrode may take the form of a wire coil, mesh, tube or other suitable structure that creates a suitable electric field. The charging electrode may be furnished with fluting, spikes, protrusions or otherwise textured to produce a suitable electric field.

A plurality of charging electrodes may be employed.

The inner assemblies, be they repulsing meshes or collecting electrodes, may be removable from the apparatus. The outer casing, repulsing mesh drums or collecting electrode drums may be removed from the apparatus.

There may be an insulating case fitted around the electrostatic precipitator apparatus.

Access ports, hatches and holes may be employed in the casings, electrodes, insulating plates or elongate member. Access ports may be positioned to allow the cleaning or replacement or repair of the apparatus or parts thereof.

The particulate matter charging electrode may be situated within the structure described by the particulate matter repulsing mesh, within the drum described by the collecting electrode or collecting plate. The particulate matter charging electrode may be situated within the drum described by the collecting plate.

The flow of gases may be induced by the incorporation of fans or other gas movers within the apparatus, before gas ingress into the apparatus or following gas egress from the apparatus.

The apparatus may be constructed using rivets, bolts, screw fittings or other suitable fittings. The apparatus may be welded or glued. Air tight seals where required may be formed using gaskets, elastomer loops or other suitable fittings and sealants. The elongate members may be attached by ait tight fittings to the apparatus, inflows and outflows by the use of screw fittings, gaskets or other suitable fittings.

A plurality of electrostatic precipitator devices may be joined in series or parallel to treat gases.

The above embodiments have been described by way of example only, and the described embodiments are to be considered in all respects only as illustrative and not restrictive. It will be appreciated that variations of the described embodiments may be made without departing from the scope of the invention which is indicated by the appended claims rather than by the foregoing description.

1-15. (canceled)

16. An electrostatic precipitator assembly, the assembly including:
an electrostatic charging mechanism for inducing a first charge to particulate material being carried in a gas flowing past the electrostatic charging mechanism;
a chamber downstream of the electrostatic charging material, the chamber including one or more electrodes which are at least one of grounded or have an opposite charge to the first charge such that the charged particulate material is attracted to and collects on the one or more electrodes; and
a further separator downstream of the one or more electrodes, the further separator including an electronically chargeable permeable member through which the gas flows, wherein the permeable member is in a form of a hollow cylinder with an open end and a closed end that includes a particulate matter deflecting plate, and wherein the permeable member has a same charge as the particulate material so as to repel the particulate material and substantially prevent the particulate material from passing through the permeable member.

17. The assembly according to claim 16, further including an electrical charging mechanism for the permeable member.

18. The assembly according to claim 16, wherein the permeable member of the further separator is made of metal.

19. The assembly according to claim 18, wherein the permeable member of the further separator is of stainless steel.

20. The assembly according to claim 16, wherein the permeable member of the further separator is in a form of a mesh.

21. The assembly according to claim 20, wherein the mesh is woven.

22. The assembly according to claim 20, wherein the mesh includes openings of between 100 and 500 microns.

23. The assembly according to claim 20, wherein the mesh includes openings of between 200 and 400 microns.

24. The assembly according to claim 16, wherein the particulate matter deflecting plate is convex.

25. A method of separating particulate material from a gas, the method comprising:
causing the gas to flow past an electrostatic charging mechanism which induces a first electrostatic charge on the particulate material;
causing the gas to flow past one or more electrodes that are grounded or have an opposite charge to the first electrostatic charge such that the particulate material adheres onto the one or more electrodes; and
causing the gas to flow through an electrically chargeable permeable member in a form of a hollow cylinder with an open end and a closed end that includes a particulate matter deflecting plate, wherein the permeable member has the first electrostatic charge so as to allow gas to pass through but repel the particulate material in the gas to prevent the particulate material from passing through the permeable member.

26. The method according to claim 25, wherein causing the gas to flow past the one or more electrodes induces a negative electrostatic charge in the particulate material.

27. The method according to claim 26, wherein the first electrostatic charge has a voltage of 10-30 kV.

28. The method according to claim 25, further comprising applying a positive charge to the one or more electrodes.

29. The method according to claim 25, further comprising charging the permeable member with the first electrostatic charge via an electrical charging mechanism.

30. The method according to claim 25, wherein the causing the gas to flow through an electrically charged permeable member includes causing the gas to flow through a permeable member of metal.

31. The method according to claim 25, wherein the causing the gas to flow through an electrically charged permeable member includes causing the gas to flow through a permeable member of stainless steel.

32. The method according to claim 25, wherein the causing the gas to flow through an electrically charged permeable member includes causing the gas to flow through a permeable member in a form of a mesh.

33. The method according to claim 32, wherein the mesh is woven.

34. The method according to claim 32, wherein the mesh includes openings of between 100 and 500 microns or between 200 and 400 microns.

35. The method according to claim 25, wherein the particulate matter deflecting plate is convex.
